(19) United States
(12) Patent Application Publication
(10) Pub. No.: US 2010/0290974 A1
(43) Pub. Date: Nov. 18, 2010

(54) TITANIUM DIOXIDE COATING METHOD AND THE ELECTROLYTE USED THEREIN

(76) Inventors: Chi-Chang HU, Hsinchu (TW); Ching-Chun HUANG, Hsinchu (TW); Kuo-Hsin CHANG, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/505,936

(22) Filed: Jul. 20, 2009

(30) Foreign Application Priority Data
May 12, 2009 (TW) 98115705

(51) Int. Cl. C01G 23/047; C25D 5/18; C01G 23/00; C01B 21/20

(52) U.S. Cl. 423/395; 205/104; 423/610; 423/385

(57) ABSTRACT

A titanium dioxide coating method is disclosed. An electrolyte containing Ti³⁺ and at least one of NO₃⁻ and NO₂⁻ is provided for an electrodeposition device. A substrate is immersed into the electrolyte and electrically connected to the electrodeposition device. A cathodic current is applied to the substrate via the electrodeposition device for reduction of NO₂⁻ or NO₃⁻. A titanium dioxide film is thus formed on the surface of the substrate. The thickness, porosity, and morphology of the titanium dioxide film can be controlled by varying the electroplating parameters, and relatively uniform deposits on complex shapes can be obtained by use of low cost instruments.

### BACKGROUND OF THE INVENTION

1. Field of the Invention

The present invention relates to a titanium dioxide coating method and the electrolyte used therein, and more particularly to an electrodeposition method for coating titanium dioxide and the electrolyte used therein.

2. Description of the Prior Art

Titanium dioxide, also known as titania, is widely recognized as an important electrode material in semiconductor photo-electrochemistry. Among the three main crystalline phases: anatase, rutile, and brookite TiO₂, the anatase form (A-TiO₂) is the most popular photo-electrode because the lowest unoccupied molecular orbital of dyes, such as N719, is very close to the conduction band of A-TiO₂.

In addition, A-TiO₂ generally shows relatively high reactivity and chemical stability under ultraviolet light excitation for water and air purifications, photocatalysts, gas sensors, electrochromic devices, and so on, further emphasizing its practical importance.

Several techniques were proposed for fabricating TiO₂, such as sol-gel, chemical vapor deposition, hydrothermal, electrospinning, anodizing, and electrodeposition.

Among these methods, cathodic deposition of TiO₂ becomes attractive because electrochemical deposition provides the advantages of controlling the thickness and morphology by varying the electroplating parameters, relatively uniform deposits on complex shapes, and use of low cost instrumentations.

To sum up, it is now a current goal to develop a cathodic deposition method for coating titanium dioxide.

### SUMMARY OF THE INVENTION

The present invention is directed to provide an electrolytic method for coating titanium dioxide to gain the advantages of controlling the thickness, porosity, and morphology by varying the electroplating parameters, relatively uniform deposits on complex shapes, and use of low cost instrumentations.

The present invention is directed to a cathodic deposition method for coating a titanium dioxide film.

The present invention is also directed to an electrolyte for coating titanium dioxide including Ti³⁺ and at least one of NO₃⁻ and NO₂⁻.

According to one embodiment, the present invention provides a titanium dioxide coating method, which includes following steps. An electrolyte containing Ti³⁺ and at least one of NO₃⁻ and NO₂⁻ is provided for an electrodeposition device. A substrate is immersed into the electrolyte and electrically connected to the electrodeposition device. A cathodic current from the electrodeposition device is applied to the substrate for reducing NO₂⁻ or NO₃⁻ and to form titanium dioxide film on the surface of the substrate.

Other advantages of the present invention will become apparent from the following descriptions taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 illustrates a flowchart of a titanium dioxide coating method according to one embodiment of the present invention;

FIG. 2 illustrates LSV (linear sweep voltammetry) curves according to one embodiment of the present invention;

FIG. 3A illustrates first and second scans of LSV curves according to one embodiment of the present invention;

FIG. 3B illustrates the corresponding EQCM (electrochemical quartz crystal microbalance) responses of the first and second scans of LSV in FIG. 3A according to one embodiment of the present invention;

FIG. 3C illustrates an enlarged view of FIG. 3B;

FIGS. 4A and 4B illustrate SEM (Scanning Electron Microscope) images according to one embodiment of the present invention;

FIGS. 4C and 4D illustrate TEM (Transmission Electron Microscope) images according to one embodiment of the present invention; and

FIGS. 4E and 4F illustrate depth profiles of XPS (X-ray photoelectron spectra) according to one embodiment of the present invention.

### DESCRIPTION OF THE PREFERRED EMBODIMENT

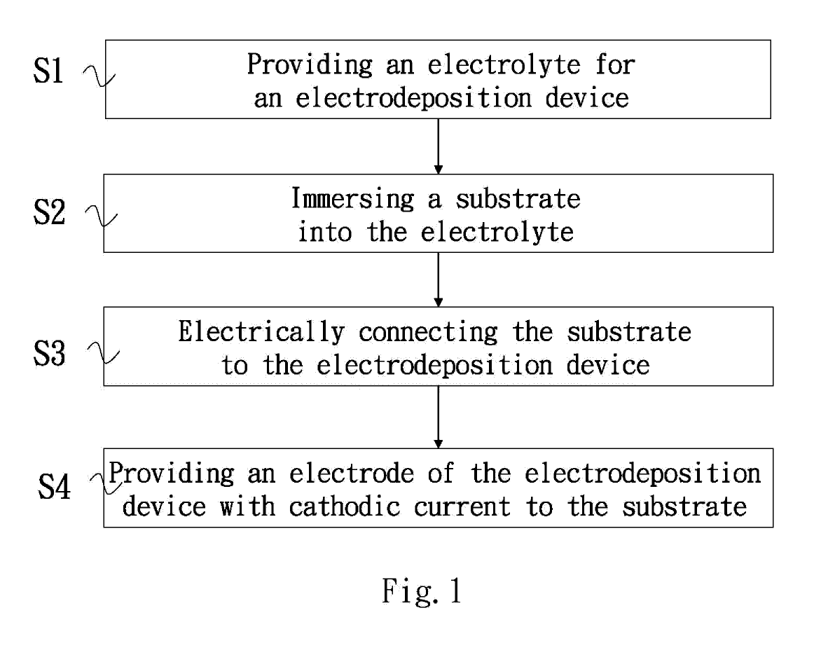

FIG. 1 illustrates a flowchart of a titanium dioxide coating method including following steps. Beginning at step S1, an electrolyte containing Ti³⁺ and at least one of NO₃⁻ and NO₂⁻ initiates the redox reaction between Ti³⁺ and NO₃⁻/NO₂⁻ to form Ti(IV) and NO₂⁻/N₂. This electrolyte is provided for an electrodeposition device. Next, at step S2, a substrate is then immersed into the electrolyte and at step S3, the substrate is electrically connected to the electrodeposition device. At step S4, a cathodic current is applied on the substrate via the electrodeposition device for reducing NO₂⁻ or NO₃⁻ to generate extensive OH⁻ for depositing TiO₂ films on the surface of substrates. The cathodic current can be applied by galvanostatic (constant dc current), potentiostatic (constant voltage), potentiodynamic, or galvanodynamic methods, or in the pulse voltage or pulse current modes.

The continuous reduction of NO₂⁻ to N₂ and NH₃ generates extensive OH⁻, and effectively enhances the deposition of TiO₂ films on the surface of substrates.

In one embodiment, a post annealing step is further performed after forming the titanium dioxide film on the surface of the substrate, wherein the post annealing step is carried out at about 100-800° C.

The following descriptions of specific embodiments of the present invention have been presented for purposes of illustrations and description, and they are not intended to be exclusive or to limit the present invention to the precise forms disclosed, and obviously many modifications and variations are possible in light of the above teaching. It is intended that the scope of the invention can be defined by the Claims appended hereto and their equivalents.

TiO₂ particulates are cathodically deposited onto graphite substrates from an electrolyte bath containing 0.47 M HCl, 25 mM TiCl₃ and 75 mM NaNO₃ in an electrodeposition device according to an embodiment of the present invention. A pretreatment procedure of graphite substrates may be performed and the detailed description thereof is herein omitted.

According to one embodiment of the present invention, the redox reaction between Ti³⁺ and NO₃⁻ during preparation of the deposition solution is herein disclosed. Nitrates, acting as the oxidizers, were reduced to NO₂ (reddish-brown bubbles) when the transparent NaNO₃ solution was added into the purple TiCl₃ solution. Since NO₂ molecules are soluble in aqueous media, they will automatically convert into NO₃⁻ and NO₂⁻. This statement is supported by the observation that reddish-brown bubbles gradually disappear within 30-40 seconds and the purple TiCl₃ solution in presence of Ti³⁺ is a colorless transparent solution indicating the formation of TiO²⁺ (see equations 1 and 2)

Ti³⁺+NO₃—→TiO²⁺+NO₂ (1)

2NO₂+H₂O→HNO₃+HNO₂ (2)

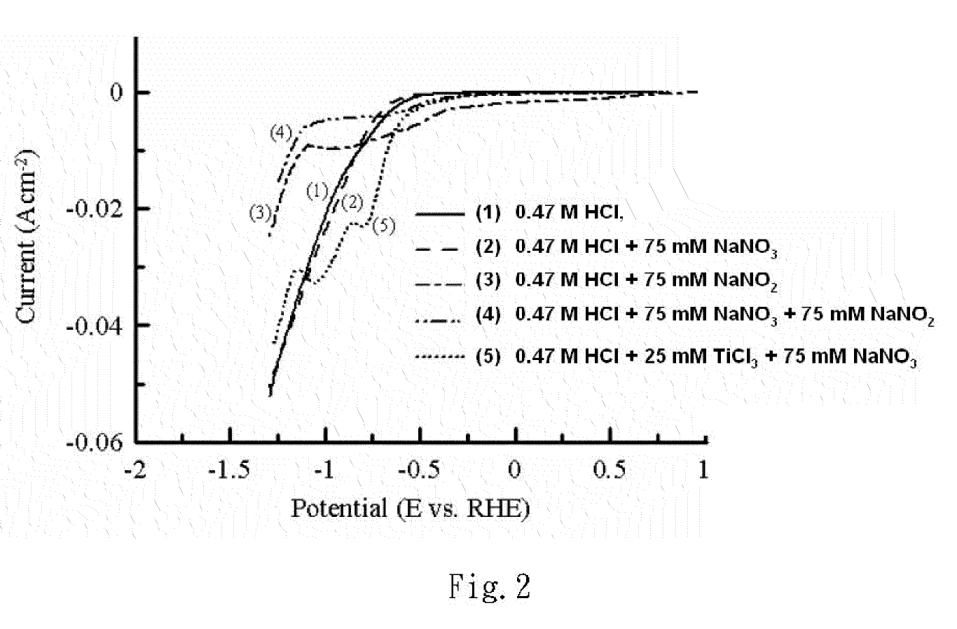

Curves 1-5 in FIG. 2 correspond to the i-E responses measured from various electrolytes. As can be seen from the curves 1 and 2, reduction commences at potentials negative to −0.6 V and no gas evolution is found at potentials positive to −0.6 V. However, a rapid generation of many bubbles is clearly observed when potentials are negative to −0.6 V, indicating H₂ evolution. On curves 3 and 4, reduction starts in the more positive potential region, revealing the facile reduction of NaNO₂. In addition, minor gas evolution commences from 0.4 V to −0.4 V with a low current density, while gas evolution ceases in the potential range from −0.4 V to −1.2 V and occurs dramatically again at potentials behind −1.2 V. The above results indicate that NO₂⁻ is responsible for the reduction in the more positive potential region with minor gas evolution, presumably due to the reduction of NO₂⁻ into N₂ molecules. Since gas evolution temporarily disappears in the potential range from −0.4 V to −1.2 V. This result suggests a further reduction of N₂ to NH₄⁺ in such a negative potential range (see equations 3 and 4).

2NO₂⁻+4H₂O+6e→N₂+8OH⁻ (3)

N₂+8H₂O+6e→2NH₄⁺+8OH⁻ (4)

On curve 5, gas evolves gently at about −0.1 V, disappears at ca. −0.4 V and, dramatically evolves again at potentials negative to −1.2 V, which completely follows the gas evolution-disappearance phenomena measured from the solution containing NO₂⁻. Accordingly, NO₂⁻ reduction in the designed deposition bath for generating concentrated OH⁻ at the vicinity of electrode surface is concluded to be an effective step in promoting the deposition of TiO(OH)₂ (see equation 5). The TiO(OH)₂ is then dehyrated to form TiO₂.

TiO²⁺+2OH⁻+xH₂O→TiO(OH)₂.xH₂O (5)

The mechanism proposed in this invention not only reasonably interprets the gas evolution/disappearance phenomena but also explains the slight increase in bath pH after the deposition, which is different from the slight decrease in pH found in previous case of NO₃⁻ reduction. Based on equations 3 and 4, OH⁻ is mainly provided by the NO₂⁻ reduction and the consequent N₂ reduction, resulting in the generation of NH₄₊. As a result, a slight increase in pH found in this formulated solution after TiO₂ deposition is reasonable because the OH⁻/electron ratio for the reduction of NO₂⁻ and N₂ is 4/3, larger than the proton/electron ratio (equal to 1) for oxygen evolution at the anode. Moreover, the deposition rate in this formulated solution is very fast, attributable to the massive generation of OH⁻.

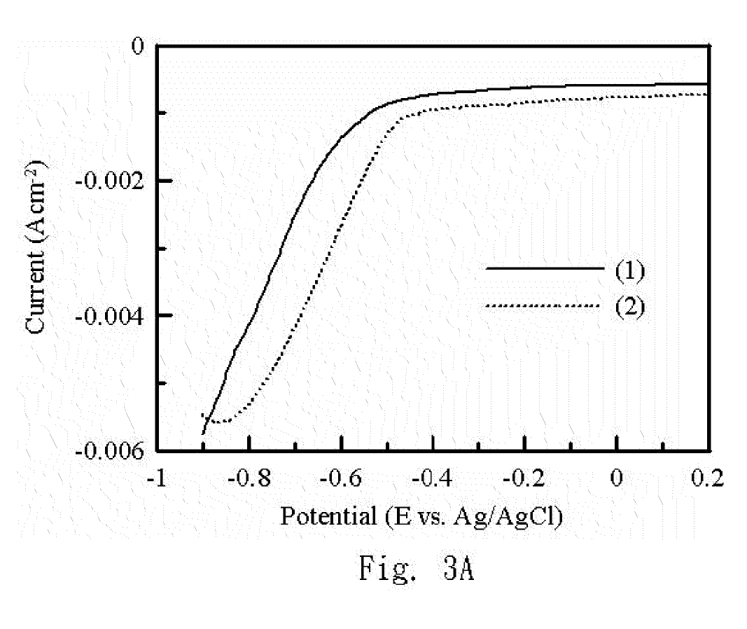

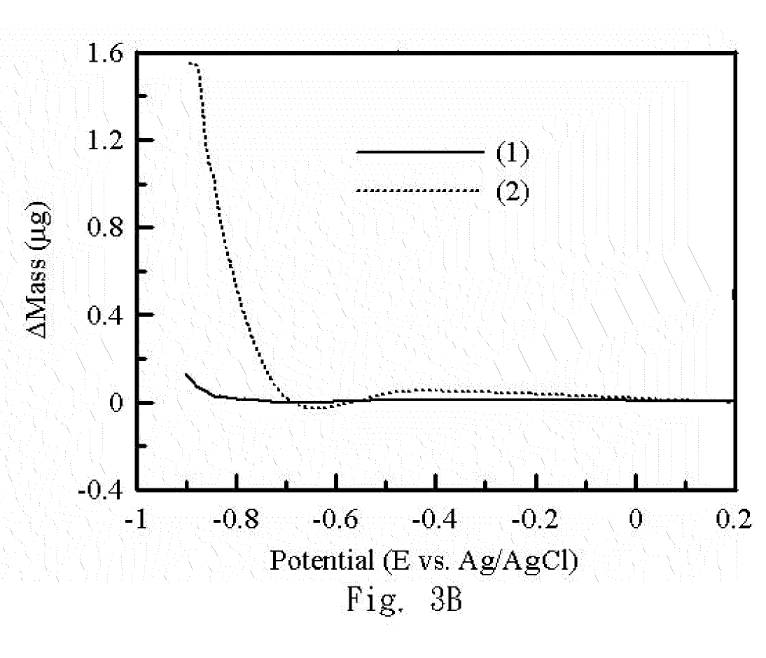

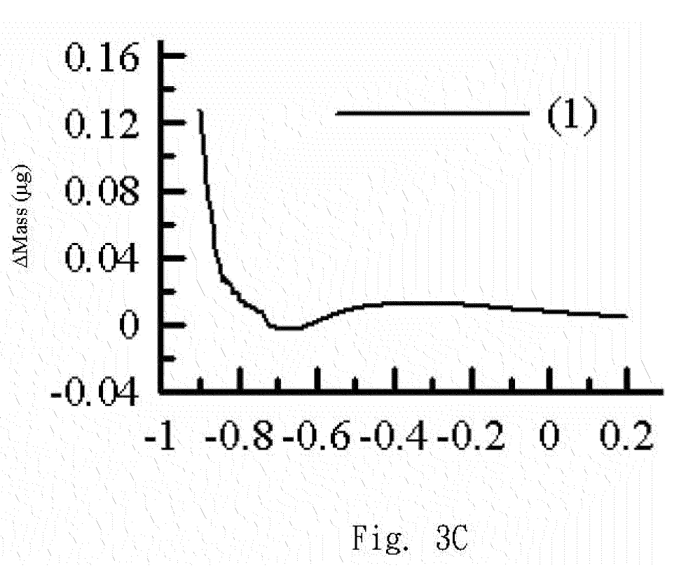

FIG. 3A illustrates the first and second scans of LSV (linear sweep voltammetry) curves and FIG. 3B illustrates the corresponding EQCM (electrochemical quartz crystal microbalance) responses of the first and second scans of LSV measured from the designed solution in order to precisely obtain the onset potential of deposition. A comparison of the i-E and mass-E responses indicates that there is always an incubation period for N₂ evolution in the positive potential range, e.g., from 0.2 to −0.7 V and from 0.1 to −0.65 V for the first and second sweeps, respectively. Although in the incubation range, NO₂⁻ starts to be reduced to N₂, no significant increase in mass is observed. The slight weight gain in this potential region is probably due to the NO₂⁻ adsorption at the cathode. Based on the EQCM result, once the potential is negative enough to generate/accumulate concentrated OH⁻, TiO²⁺ will combine with OH⁻ to form TiO₂ and an obvious weight gain is visible behind this onset potential of deposition (−0.85 and −0.65 V for the first and second scans, respectively). Also note the positive shift in the onset potential of deposition during the second scan. This phenomenon is probably due to the electrocatalytic property of TiO(OH)₂ and TiO₂ already deposited onto the graphite surface during the first scan for NO₂⁻/N₂ reduction.

The electrodes were cleaned in an ultrasonic DI water bath and dried under a cool air flow after cathodic deposition. After cleaning and drying, some electrodes were annealed at 400° C. in air for 1 hr. The morphologies were examined by a FE-SEM (Field-Emission Scanning Electron Microscope, FE-SEM). The EQCM study was performed by an electrochemical analyzer, CHI 4051A in a one-compartment cell. The microstructure and SAED (selected area electron diffraction, SAED) patterns of as-deposited and annealed TiO₂ deposits were observed through a TEM (FEI E.O Tecnai F20 G2). The depth profiles of Ti and O were measured by an X-ray photoelectron spectrometer (XPS, ULVAC-PHI Quantera SXM), employed Al monochromator (hv=1486.69 eV) irradiation as the photosource.

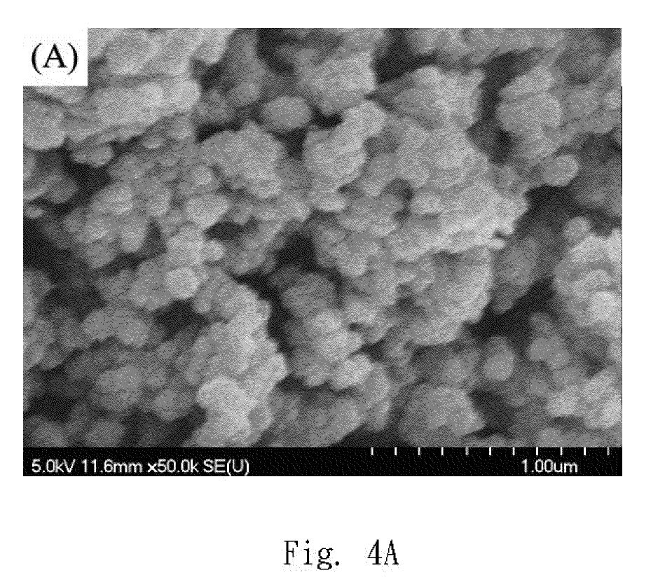

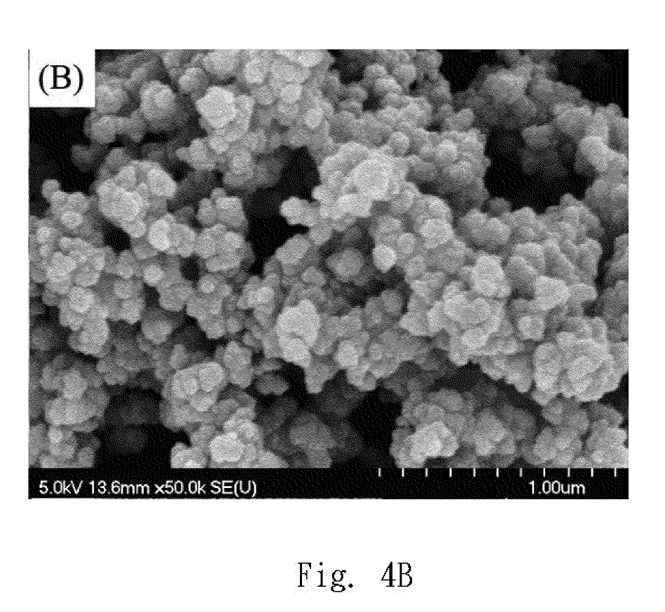

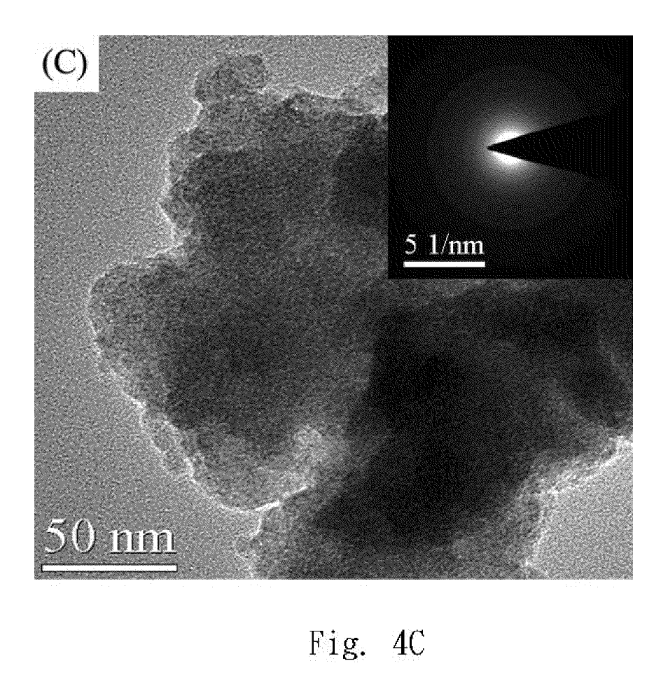

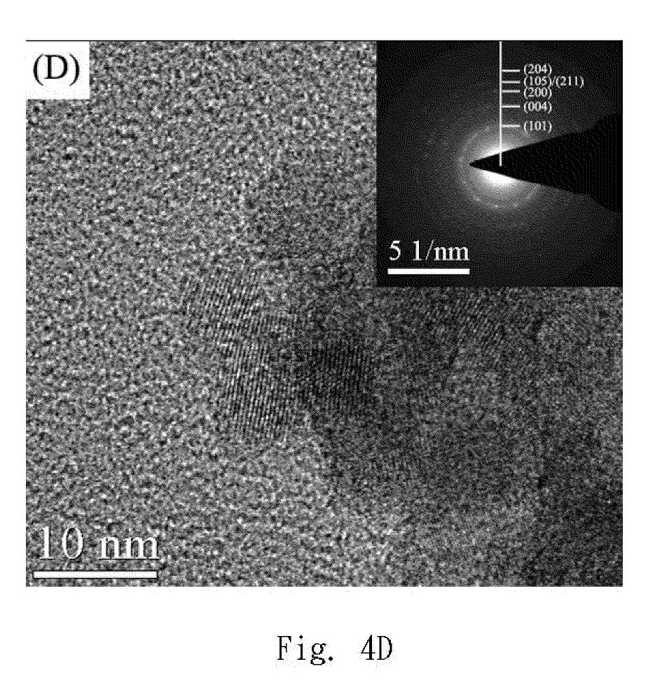

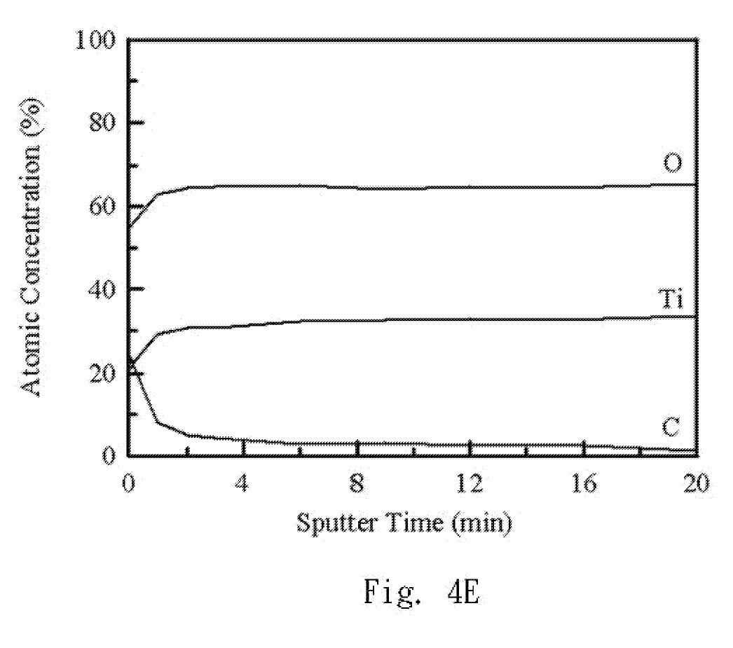

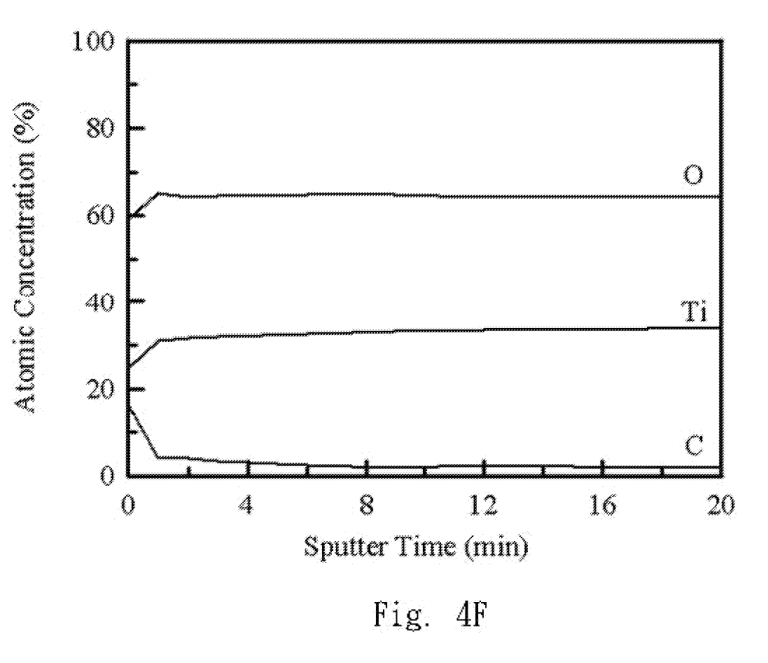

It is favorable to prepare porous A-TiO₂ films by combining cathodic deposition from this designed Ti³⁺+NO₃⁻ solution and post-deposition annealing. As illustrated in FIGS. 4A and 4B, TiO₂ films before and after annealing are porous and the particle size is roughly estimated to be 60-100 nm. The porous nature of TiO₂ films prepared in this invention is probably due to the extensive tiny bubble evolution during the deposition. The particulates are considered as aggregates of TiO₂ primary particles.

The average size for as-deposited TiO₂ primary particles is about 6 nm, which is enlarged by post-deposition annealing (ca. 10 nm for TiO₂ annealed at 400° C.) from FIGS. 4C and 4D. The lattice clearly visible in FIG. 4D and the diffraction rings in its inset indicate the anatase structure which is transformed from the amorphous, as-deposited TiO₂ by post-deposition annealing. FIGS. 4E and 4F illustrate the depth profiles of Ti, O, and C for as-deposited and annealed samples. Clearly, the atomic ratio of Ti/O is approximately constant (ca. ½) within the whole oxide matrix.

This result confirms the formation of TiO₂ in the as-prepared and annealed films. Accordingly, combining cathodic deposition from this designed Ti³⁺ +NO₃⁻ solution and post-deposition annealing is favorable for preparation of porous A-TiO₂ films.

The aforementioned embodiment exemplified the reaction from the electrolyte solution containing Ti³⁺+NO₃⁻; however, the redox reaction between Ti³⁺ and NO₂⁻ in an electrolyte solution can be used for depositing titanium dioxide films (See Equation 6 and Equation 3-5).

6Ti³⁺+2NO₂-+2H₂O→6TiO²⁺+N₂+4H⁺ (6)

To sum up, a titanium dioxide coating method according to the present invention includes a cathodic deposition using an electrolytic solution containing Ti³⁺ and at least one of NO₃⁻ and NO₂⁻, and a post-deposition annealing process, which is favorable for preparing porous A-TiO₂ films. The redox reaction between Ti³⁺ and NO₃⁻/NO₂⁻ to form Ti(IV) and NO₂⁻/N₂ prior to cathodic deposition effectively promotes the TiO₂ deposition. The continuous reduction of NO₂⁻ to N₂ and NH₃ generates extensive OH⁻ and effectively enhances the deposition of TiO₂ for forming a TiO₂ film at the substrate surface.

The porous, anatase structure of annealed TiO₂, examined by FE-SEM, TEM, and SAED analyses is expected to be good for the dye-sensitized solar cell (DSSC) application. In addition, A-TiO₂ may be applicable for water and air purifications, photocatalysts, gas sensors, electrochromic devices, and so on.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A titanium dioxide coating method comprising:
providing an electrolyte containing Ti³⁺ and at least one of NO₃⁻ and NO₂⁻ for an electrodeposition device;
immersing a substrate into the electrolyte;
electrically connecting the substrate to the electrodeposition device; and
applying a cathodic current to the substrate via the electrodeposition device for reducing NO₂⁻ or NO₃⁻ to generate extensive OH⁻ for forming a titanium dioxide film on the surface of the substrate.

2. The method as claimed in claim 1 further comprising a post annealing step after forming the titanium dioxide film.

3. The method as claimed in claim 2, wherein the post annealing step is carried out at about 100-800° C.

4. The method as claimed in claim 1, wherein the cathodic current is applied by galvanostatic (constant dc current), potentiostatic (constant voltage), potentiodynamic, or galvanodynamic methods, or in the pulse voltage or pulse current modes.

5. The method as claimed in claim 1, wherein NO₂⁻ and TiO²⁺ are generated by a reaction between Ti³⁺ and NO₃⁻, and NO₂⁻ is generated by the reaction between NO₂ and water.

6. The method as claimed in claim 5, wherein OH⁻ is generated by reduction of NO₂⁻ at the cathode.

7. The method as claimed in claim 6, wherein TiO(OH)₂ is generated from a reaction between TiO²⁺ and OH⁻ and then dehydrated to form TiO₂.

8. The method as claimed in claim 7, wherein the generation of OH⁻ by the NO₂⁻ reduction at the cathode is catalyzed by TiO(OH)₂ and TiO₂.

9. The method as claimed in claim 1, wherein TiO²⁺ and N₂ are generated from the reaction between Ti³⁺ and NO₂⁻.

10. The method as claimed in claim 9, wherein OH⁻ is generated by reduction of NO₂⁻/N₂ at the cathode.

11. The method as claimed in claim 10, wherein TiO(OH)₂ is generated from a reaction between TiO²⁺ and OH⁻ and then dehydrated to form TiO₂.

12. The method as claimed in claim 11, wherein the generation of OH⁻ by the NO₂⁻/N₂ reduction at the cathode is catalyzed by TiO(OH)₂ and TiO₂.

13. The method as claimed in claim 1, wherein the electrolyte is acidic.

14. A titanium dioxide film is obtained by the method as claimed in claim 1.

15. The titanium dioxide film as claimed in claim 14 is crystalline.

16. The titanium dioxide film as claimed in claim 14 is amorphous.

17. The titanium dioxide film as claimed in claim 14 is porous.

18. An electrolyte for titanium dioxide coating comprising:
Ti³⁺ and at least one of NO₃⁻ and NO₂⁻.

19. The electrolyte as claimed in claim 18 is acidic.
